(19) United States
(12) Patent Application Publication
(10) Pub. No.: US 2025/0252959 A1
(43) Pub. Date: Aug. 7, 2025

(54) ELECTRONIC DEVICE WITH DICTATION STRUCTURE

(71) Applicant: Apple Inc., Cupertino, CA (US)

(72) Inventor: Paul X. Wang, Cupertino, CA (US)

(21) Appl. No.: 18/435,955

(22) Filed: Feb. 7, 2024

(51) Int. Cl. G10L 15/25; G06F 3/01; G06V 40/20; G10L 15/26

(52) U.S. Cl. CPC G10L 15/25; G06F 3/013; G06F 3/017; G06V 40/20; G10L 15/26

(57) ABSTRACT

A head-mountable device includes a display, a display frame disposed around the display, a vision sensor carried by the display frame and oriented externally in a downward direction that, when donned on a head of a user, is configured to detect mouth movement. The head-mountable devices further includes a processor and a memory device storing instructions that, when executed by the processor, cause the processor to convert visual data of the mouth movement to a text input.

### FIELD

The described examples relate generally to electronic devices. More particularly, the present examples relate to text input for electronic devices.

### BACKGROUND

Recent advances in portable computing have enabled head-mountable devices that provide augmented reality and virtual reality (AR/VR) experiences to users. Such head-mountable devices can include various components such as a display, a viewing frame, lenses, optical components, a battery, motors, speakers, sensors, cameras, and other components. These components can operate together to provide an immersive user experience.

Users typically interact with and input text to the head-mountable devices by using hand gestures and/or by speaking audible commands or phrases, due to the lack of a keyboard or other designated text input device. Audible dictation can be particularly inconvenient when the user is in a public or other environment where discretion, privacy, or quiet may be desired. Similarly, background noise in some environments can interfere with the ability of the head-mountable device to accurately and reliably recognize voice inputs from the user. Therefore, there is a need for a head-mountable device which can allow the user to easily dictate inputs to the head-mountable device.

### SUMMARY

In at least one example, a head-mountable device can include a display, a display frame disposed around the display, a vision sensor carried by the display frame and oriented externally in a downward direction that, when donned on a head of a user, is configured to detect mouth movement. The head-mountable device can further include a processor and a memory device storing instructions that, when executed by the processor, cause the processor to convert visual data of the detected mouth movement to a text input.

In one example, the head-mountable device can further include an additional sensor configured to detect at least one of a facial vibration or a facial deformation. In a further example of the head-mountable device, the additional sensor can be positioned in direct contact with a face of the user. In a further example of the head-mountable device, the processor can activate a silent text input mode in response to receiving sensor data from the additional sensor.

In one example, the head-mountable device can further include a second sensor including an internal-facing camera to detect an input selection based on eye gaze, and a third sensor including an external-facing camera to detect a hand gesture indicating confirmation of the input selection.

In at least one example, a system includes a wearable device communicatively coupled to an electric device with a first sensor. The wearable device includes a second sensor, a processor, and a memory device storing instructions that, when executed by the processor, cause the processor to identify sensor data from the first sensor and the second sensor, generate a predicted dictation based on the sensor data, and present, for display at the wearable device, a graphical representation of the predicted dictation.

In one example of the system, the first sensor is a first type of sensor, and the second sensor is a second type of sensor different from the first type of sensor. In one example of the system, the first type of sensor can be an acoustic sensor, a pressure sensor, a strain gauge, a vibration detector, a breath detector, or a biometric sensor. The second type of sensor can be a camera.

In one example of the system, the first sensor can be oriented in a first orientation, and the second sensor can be oriented in a second orientation that differs from the first orientation. In one example of the system, in the first orientation, the first sensor can include a full view of a mouth of a user and in the second orientation, the second sensor can include a partial view of the mouth of the user.

In one example the system can further include an electronic device that includes an external client device. In one example of the system, generating the predicted dictation can include receiving contextual awareness. In one example of the system, the contextual awareness is based on user activity. In one example of the system, generating the predicted dictation can include using a machine-learning model.

In at least one example, a wearable apparatus includes a display housing including an optical dictation sensor, a display positioned within the display housing, and a facial interface connected to the display housing, the facial interface including a motion sensor, the motion sensor and the optical dictation sensor communicatively coupled to a processor.

In one example of the wearable apparatus, the motion sensor can be disposed in proximity to a zygoma region or a maxilla region of a face of a user when donned.

In one example of the wearable apparatus, the motion sensor can include at least one of a pressure sensor or a strain gauge.

In one example of the wearable apparatus, the optical dictation sensor can include a pair of vision sensors positioned within the display housing.

In one example, the wearable apparatus can further include a memory device and a processor. The memory device can include instructions that, when executed by the processor, cause the processor to activate a silent dictation mode in response to detecting a user input to dictate.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a top view profile of a head-mountable device worn on a user head, according to one example;

FIG. 1B illustrates a side view profile of a head-mountable device worn on a user head, according to one example;

FIG. 1C illustrates a front view profile of a head-mountable device worn on a user head, according to one example;

FIG. 2 illustrates a front view profile of a head-mountable device with cameras, according to one example;

FIG. 3 illustrates a schematic diagram of using a machine-learning model to generate a predicted dictation from visual data obtained from the camera, according to one example;

FIG. 4 illustrates a schematic diagram of using a machine-learning model to generate a predicted dictation from visual data as well as non-visual data and/or additional visual data, according to one example;

FIG. 5 illustrates a front view profile of a head-mountable device with various cameras, according to one example;

FIG. 6A illustrates a front view profile of a head-mountable device with non-visual sensors, according to one example;

FIG. 6B illustrates a side view profile of a head-mountable device with non-visual sensors, according to one example;

FIG. 7 illustrates a side view profile of a head-mountable device communicatively coupled to an electronic device including a first sensor, according to one example;

FIG. 8 illustrates a user interface (UI) displaying a graphical representation of a predicted dictation displayed on the display of a head-mountable device, according to one example;

FIG. 9A illustrates a schematic of training a dictation machine-learning model of a head-mountable device to generate a predicted dictation, according to one example;

FIG. 9B illustrates a system for training a head-mountable device to generate a predicted dictation, according to one example; and

FIG. 10 shows a high-level block diagram of a computer system that can be used to implement examples of the present disclosure.

### DETAILED DESCRIPTION

Reference will now be made in detail to representative examples illustrated in the accompanying drawings. It should be understood that the following descriptions are not intended to limit the examples to any one preferred example. To the contrary, it is intended to cover alternatives, modifications, and equivalents as can be included within the spirit and scope of the described examples as defined by the appended claims.

The following disclosure relates to head-mountable devices. In particular, the following disclosure relates to a head-mountable device with silent dictation structure. In at least one example, a head-mountable device can include a viewing frame and a securement arm (or strap/band) extending from the viewing frame. Examples of head-mountable electronic devices can include virtual reality or augmented reality devices that include an optical component. In the case of augmented reality devices, optical eyeglasses or frames can be worn on the head of a user such that optical windows, which can include transparent windows, lenses, or displays, can be positioned in front of the user's eyes. In another example, a virtual reality device can be worn on the head of a user such that a display screen is positioned in front of the user's eyes. The viewing frame can include a housing (e.g., a display housing or display frame) or other structural components supporting the optical components, for example lenses or display windows, or various electronic components.

Additionally, a head-mountable electronic device can include one or more electronic components used to operate the head-mountable electronic device. These components can include any components used by the head-mountable electronic device to produce a virtual or augmented reality experience. For example, electronic components can include one or more projectors, waveguides, speakers, processors, batteries, circuitry components including wires and circuit boards, or any other electronic components used in the head-mountable device to deliver augmented or virtual reality visuals, sounds, and other outputs. The various electronic components can be disposed within the electronic component housing. In some examples, the various electronic components can be disposed with in or attached to one or more of the display frame, the electronic component housing, or the securement arm.

A user can interact with a conventional head-mountable device via audibly speaking, using hand gestures, or external keyboards or controls. The use of audibly speaking or hand gestures can be inconvenient in certain settings, such as in public areas, areas where the user is required to be quiet or does not want to disturb nearby people, and noisy or crowded areas which prevent the head-mountable device from deciphering audible dictation. Entering text or commands using hand gestures can be cumbersome and slow, since unlike using a keyboard, the user may not have associated muscle memory for each key. However, keyboards themselves can be inconvenient for the user to carry and transport and can require charging or an external power source, which may not be readily available.

The following disclosure relates to a head-mountable device with a silent dictation structure. A silent dictation structure refers to hardware (e.g., sensors, processors, memory, etc.) and/or software (e.g., computer-executable instructions, trained machine-learning models, etc.) of the head-mountable device that allow the user to input text or commands to the head-mountable device without the need for uttering audible commands or using an external device or keyboard.

A head-mountable device with a silent dictation structure can allow the user to input text or present commands to the head-mountable device in public settings, quiet settings, or noisy settings. For example, a head-mountable device can include a display, a display frame disposed around the display, a vision sensor carried by the display frame and oriented externally in a downward direction that, when the head-mountable device is donned on a head of the user, is configured to detect mouth movement. The head-mountable device can include a processor and a memory device storing instructions that, when executed by the processor, cause the processor to convert visual data of the mouth movement to a text input.

A vision sensor can include one or more cameras, also referred to as jaw cameras or mouth cameras, of the head-mountable device that are aimed at least partially towards the mouth of the user to capture movements of the mouth of the user. The head-mountable device can receive silent dictation by deciphering words that are formed by the mouth of the user, even if the user does not utter audible sound. The silent dictation can be used as a text input or system commands.

In some examples, the head-mountable device can include additional sensors that aid in silent dictation. Additional sensors can include pressure sensors, strain gauges, internal cameras aimed at the user's eyes, nose, cheek, etc., breathing or heart rate monitors. Such sensors can be used to optimize accuracy of the jaw cameras and/or provide context (e.g., physiological context) for visual data, such as by predicting emotions.

In some examples, the head-mountable device can use contextual information to aid in silent dictation. For example, global positioning system (GPS) data can indicate that the user is in a location, such as a gym, and the head-mountable device can predict dictation relating to common gym-related phrases or terms. In another example, application data, search history, browser cookies, and the like can provide indication of likely dictations from the user.

Additional sensors, such as the sensors described above and/or contextual data can also be used to trigger a silent dictation mode of the head-mountable device. A silent dictation mode can refer to a mode of the head-mountable device wherein the user forms non-audible words with their mouth. For example, in a private environment, such as the user's home, the user may prefer to provide audible dictation to the head-mountable device; while in a public environment, such as a library, the user may prefer to provide silent dictation. In an additional or alternate example, the silent dictation mode can be activated in response to at least one sensor of the head-mountable device detecting another person within a threshold vicinity of the at least one sensor.

In some examples, the head-mountable device can be trained to optimize recognition and accuracy of silent dictation. A head-mountable device can be trained when the user initially activates the head-mountable device for the first time. The head-mountable device can request that the user speaks or mouths predetermined phrases or makes predetermined facial expressions. The head-mountable device can record the training data to interpret the user's silent dictation. Inputs from sensor data, contextual data, and other inputs can be used individually or in combination to generate the predicted silent dictation.

In some examples, the head-mountable device can use machine-learning models trained on various input features. Once trained, the above-listed inputs, along with other inputs, can be utilized by a machine-learning model to generate the predicted dictation. Historical data can be used by a machine-learning model to improve accuracy of the predicted dictation.

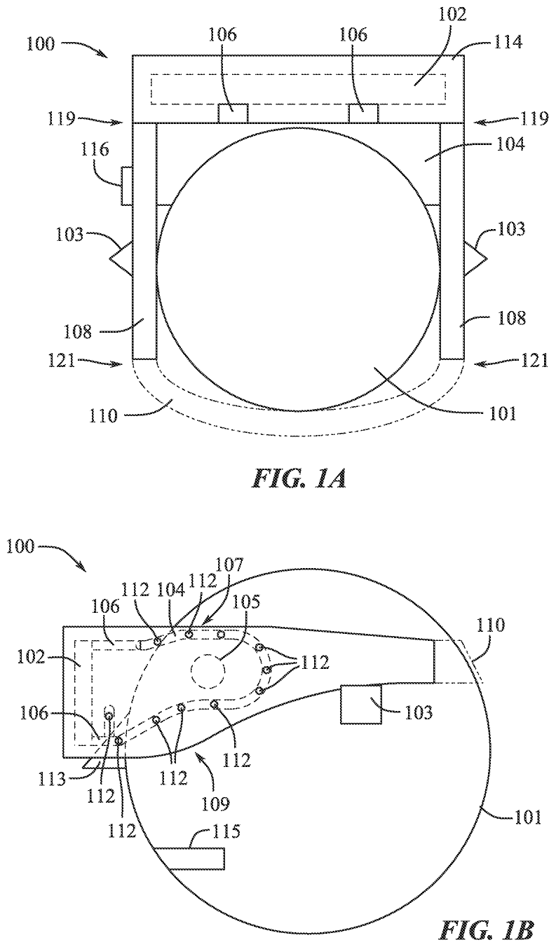

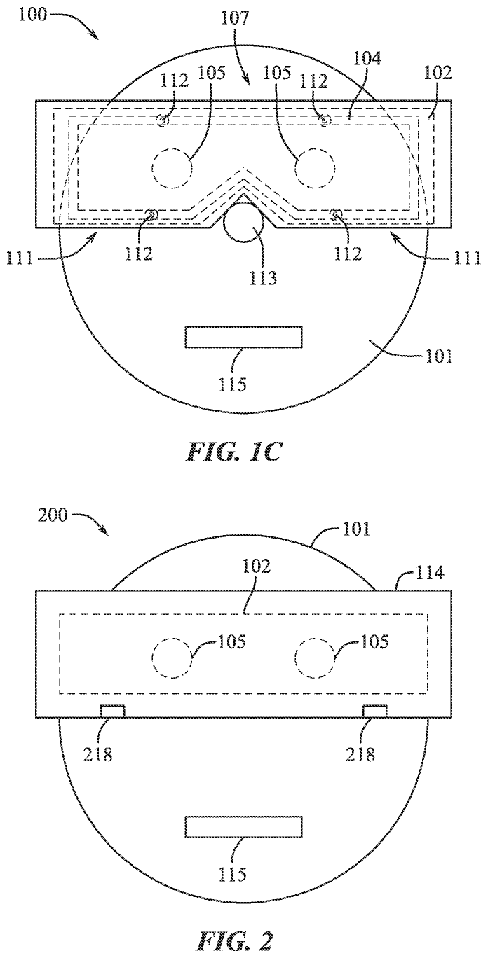

These and other examples are discussed below with reference to FIGS. 1-10. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A-1C illustrate a top view profile, a side view profile, and a front view profile, respectively, of a head-mountable device 100 worn on a user head 101, according to one example. While the present systems and methods are described in the context of a head-mountable device 100, the systems and methods can be used with any wearable apparatus, wearable electronic device, or any apparatus or system that can be physically attached to a user's body, but are particularly relevant to an electronic device worn on a user's head. The systems and methods can also be used with any electronic device with a camera or a sensor including a field of view at least partially including the user's mouth.

The head-mountable device 100 can include a display 102 or other optical component (e.g., one or more optical lenses or display screens in front of the eyes of the user). The display 102 can include a screen for presenting augmented reality visualizations, a virtual reality visualization, or other suitable visualization. The display 102 can be part of an optical module, which can include sensors, cameras, light emitting diodes, an optical housing, a cover glass, sensitive optical elements, etc. The head-mountable device 100 can include a display frame 114 disposed around the display 102. The display 102 can be disposed on or within a display frame 114. The display frame 114 can be a display housing which houses the display 102 and other optical components, such that the display 102 is positioned within the display frame 114. For example, the display 102 can be positioned within the display housing facing the user's face to display graphical information to the user.

The head-mountable device 100 can include arms 108. The arms 108 can secure the head-mountable device 100 to the user's head 101. The arms 108 each have a proximal end 119 and a distal end 121. The proximal end 119 can be connected to the display frame 114. The arms 108 are connected to the display frame 114 and extend distally toward the rear of the head 101. The arms 108 are configured to secure the display 102 in a position relative to the user head 101 (e.g., such that the display 102 is maintained in front of a user's eyes). For example, the arms 108 can extend over the user's ears 103. In certain examples, the arms 108 rest on the user's ears 103 to secure the head-mountable device 100 via friction between each of the arms 108 and the user head 101. For example, the arms 108 can apply opposing pressures to the sides of the user head 101 to secure the head-mountable device 100 to the user head 101.

In at least one example, a strap 110 can be connected to the distal ends of both of the arms 108. The strap 110 can provide additional support to secure the head-mountable device 100 to the user's head 101, for example, by wrapping around the back of the user's head 101. The strap 110 can compress the head-mountable device 100 against the user head 101. In particular examples, the strap 110 is connected to the display frame 114.

The head-mountable device 100 can include a facial interface 104, such as a light seal or other foam or soft feature extending about a perimeter and an inner surface of the display frame 114. As used herein, the term “facial interface” refers to a portion of the head-mountable device 100 that engages a user face via direct contact. For example the facial interface can be connected to the display frame 114 (display housing). In particular, a facial interface includes portions of the head-mountable device 100 that conform to (e.g., compress against) regions of a user face. For example, a facial interface can include a pliant (or semi-pliant) face track that spans the forehead region 107, wraps around the eyes 105, contacts the zygoma region 109 and maxilla region 111 of the face, and bridges the nose 113. As used herein, the term “forehead region” refers to an area of a human face between the eyes and the scalp of a human. Additionally, the term “zygoma region” refers to an area of a human face corresponding to the zygomatic bone structure of a human. Similarly, the term “maxilla region” refers to an area of a human face corresponding to the maxilla bone structure of a human.

In at least one example, the facial interface 104 is connected to the display frame 114 and can include a motion sensor that provides sensor data to a processor, which in turn can activate an optical dictation sensor, as further described in reference to at least FIG. 2 and FIGS. 5-7.

In addition, a facial interface can include various components forming a structure, webbing, cover, fabric, or frame of a head-mountable device disposed between the display frame 114 and the user skin. In particular implementations, a facial interface can include a seal (e.g., a light seal, environment seal, dust seal, air seal, etc.). It will be appreciated that the term “seal” can include partial seals or inhibitors, in addition to complete seals (e.g., a partial facial interface where some ambient light is blocked and a complete facial interface where all ambient light is blocked when the head-mountable device is donned). The facial interface 104 can compress against the user's face to provide comfort and to block out ambient light from an ambient or external environment. As used herein, an “inner surface” refers to a surface of the head-mountable device 100 that is oriented to face towards (or contact) a human face or skin. By contrast, as used herein, an “outer surface” refers to an exterior surface of the head-mountable device 100 that outwardly faces the ambient environment.

The head-mountable device 100 can include a vision sensor 106, such as a camera, carried by the display frame 114. The vision sensor 106 is also referred to herein as a jaw camera. The vision sensor 106 can be oriented externally in a downward direction that, when the head-mountable device is donned on the head 101 of the user, is configured to detect mouth movement from a mouth 115 of the user. Mouth movement can include movements of the lip, cheek, jaw, etc., and changes in mouth opening, interplay between the teeth, tongue, and lip, as well as other linguistic mechanics. The vision sensor 106 can be configured to detect mouth movement for silent dictation prediction or text/command input, as described in additional detail below.

In some examples, the head-mountable device 100 can include additional sensors 112. The additional sensors 112 can include acoustic sensors, pressure sensors, strain gauges, vibration detectors, breath detectors, biometric sensors, and/or additional cameras. The additional sensors 112 can be used to optimize accuracy of the silent dictation predication (in some cases via a machine-learning model) and/or to trigger the head-mountable device 100 to enter a silent dictation mode. A silent dictation mode can refer to a mode of the head-mountable device 100 wherein the user forms silent or non-audible words with their mouth, or provides various facial expressions.

The head-mountable device 100 can include an electronics pod 116. As depicted in FIG. 1A, the electronics pod 116 can be disposed on one of the arms 108. However, in other examples, the electronics pod 116 can be disposed on the strap 110, the display frame 114, or elsewhere on the head-mountable device 100. The electronics pod 116 can include various electronic components, such a controllers, microcontrollers, processors, memory, batteries, power port(s), etc. At least some of the various electronic components can be electrically and/or communicatively coupled to the vision sensor 106.

Any of the features, components, and/or parts, including the arrangements and configurations thereof shown in FIGS. 1A-1C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 1A-1C. Additional details of an optical dictation sensor or jaw camera are described below in reference to FIG. 2.

FIG. 2 illustrates a front view profile of a head-mountable device 200 with cameras 218, according to one example. The head-mountable device 200 can be substantially similar to, or the same as, the head-mountable device 100 of FIG. 1, as noted by similar or identical reference numbers.

The display frame 114 (also referred to as a display housing) can include one or more optical dictation sensors. As illustrated in FIG. 2, the optical dictation sensors can be camera(s) 218 or other types of vision sensors. In certain examples, optical dictation sensors can include photoelectric sensors, laser sensors, LIDAR sensors, infrared sensors, etc. Optical dictation sensors can detect presence, orientation, movement, etc. of one or more objects (or predetermined positional markers, biometric markers, or pin-point locations on an object). In at least one example, the optical dictation sensors can include a pair of vision sensors positioned within the display housing or display frame 114. In one example the head-mountable device 200 includes two cameras 218. In other examples, the head-mountable device 200 can include one, three, or more camera(s) 218. The camera(s) 218 can be oriented externally in a downward direction towards the mouth 115 of the user. The camera(s) 218 can be configured to take periodic pictures, capture video, or otherwise obtain visual data of movement of the mouth 115 of the user. For example, visual data can include lip movement, cheek movement, jaw movement, changes in mouth opening, speed of mouth movement, interplay between the teeth, tongue, and/or lip, as well as other linguistic mechanics. Including two or more cameras 218 on the head-mountable device 200 can allow for the visual data captured by the camera(s) to be reconstructed (e.g., stitched, combined, or otherwise processed according to image processing techniques) to form a combined image or a three-dimensional image of the mouth, thereby increasing accuracy of the predicted dictation.

In some examples, as discussed in further detail below, the head-mountable device can include a processor and a memory device storing instructions that, when executed by the processor, cause the processor to convert the visual data of the mouth movement to a text input (e.g., a predicted silent dictation). In some examples, the processor can utilize one or more machine-learning models to convert the visual data into the predicted dictation.

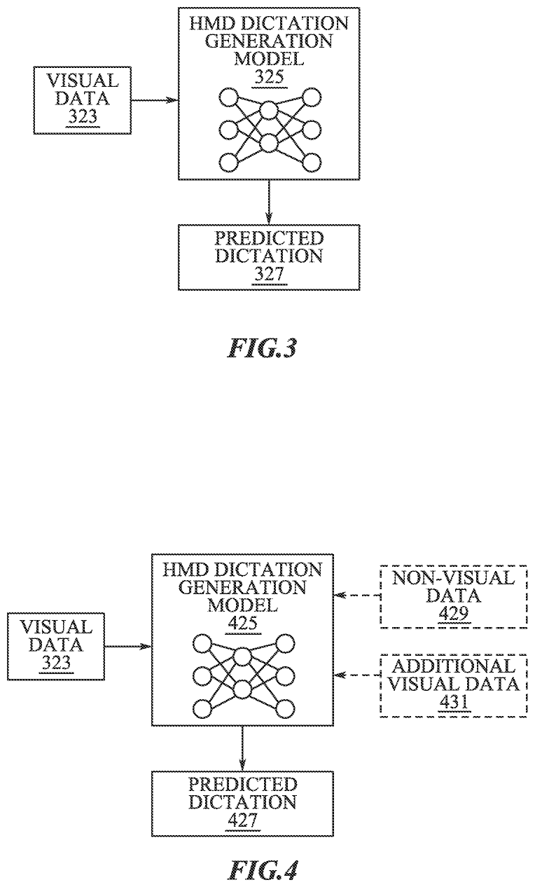

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Additional details of generating predicted dictation from visual data are described below in reference to FIGS. 3-4.

FIG. 3 illustrates a schematic diagram of using a machine-learning model 325 to generate a predicted dictation 327 from visual data 323 obtained from the camera 218, according to one example. As described above, the camera 218 can obtain image frames (e.g., via period photos or continuously recorded video) of mouth movement of the user. In particular, the visual data 323 can be obtained without including audio data, such that it is representative of the user mouthing an intended dictation.

The head-mountable device 200 can use the machine-learning model 325 (which may be stored in the memory of the head-mountable device 200 or on an external server communicatively coupled to the head-mountable device 200). The machine-learning model 325 can be configured to parse and recognize the user's intended dictation from the visual data 323 to generate a predicted dictation 327. The predicted dictation 327 can be input to the head-mountable device 200 as text or recognized as a command.

Over time, the machine-learning model 325 can optimize its accuracy of generating the predicted dictation. For example, the machine-learning model 325 can retain and/or learn from historical data, including visual data 323 collected over time. Additionally or alternatively, the machine-learning model 325 can receive input corrections from the user when the predicted dictation 327 differs from the intended dictation.

In some examples, the machine-learning model 325 can generate second predicted dictation based on learned or retained patterns of the predicted dictation 327. The machine-learning model 325 can attempt to guess the user's next word(s) or phrase(s) before the machine-learning model 325 receives the visual data 323.

FIG. 4 illustrates a schematic diagram of a method of using a machine-learning model 425 to generate a predicted dictation 427 from visual data 323 as well as non-visual data 429 and/or additional visual data 431, according to one example. By including additional data such as the non-visual data 429 and/or the additional visual data 431, the machine-learning model 425 can optimize the accuracy of the predicted dictation 427.

In some examples, the head-mountable devices 100/200 can include additional cameras. The fields of view of the additional cameras can include other parts of the user's face. For example, some additional cameras can obtain additional visual data 431 of the user's eyes 105 (e.g., eye movement, flickering, sight direction) or pupils (e.g., dilating, contracting). Some additional cameras can obtain additional visual data 431 of the user's nose or detectable movements of the nose, such as nose flaring or nose tip movements.

One type of non-visual data 429 can include contextual data. Contextual data can include data relating to the user's activity or location which can provide indication of the subject of the user's current activity/location for generating the predicted dictation 427. For example, contextual data be based on user activity. User activity can refer to historical data including cookies, browser history, text messages, audio data, global positioning system (GPS) data, or simultaneous use of a software application. For example, GPS data can indicate that the user is at a gym, grocery store, in the wilderness, traveling, etc. Web browser history, recent web searches, browser cookies, applications, text messages, emails, calendars, etc. can indicate recent relevant topics of interest of the user.

Another type of non-visual data 429 can include physical measurements of the user. The head-mountable devices 100 and 200 can include additional sensors that are disposed near or in contact to the forehead region 107, the zygoma region 109, the maxilla region 111, the nose 113, the mouth 115, and/or otherwise near or in contact with the user's head 101. The additional sensors can obtain physical measurements including facial strain, pressure, temperature, respiration, pulse, etc. For example, respiration patterns can be correlated with mouth movement, such as correlating exhaling/inhaling with speech patterns.

In some examples, similar to the machine-learning model 325, the machine-learning model 425 can retain historical data including the visual data 323, the non-visual data 429, and/or the additional visual data 431 to optimize accuracy of the predicted dictation 427. Further, the machine-learning model 425 can generate a second predicted dictation based on the historical data.

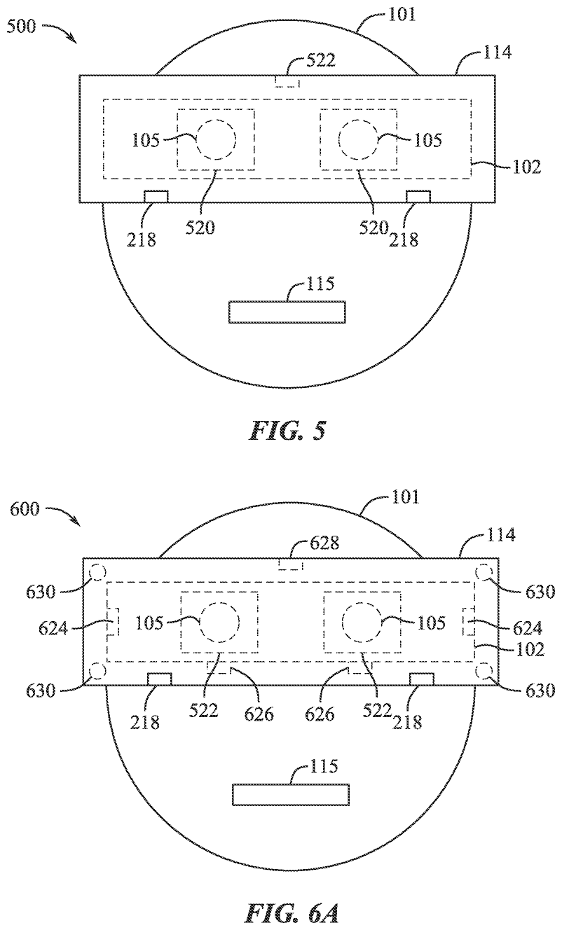

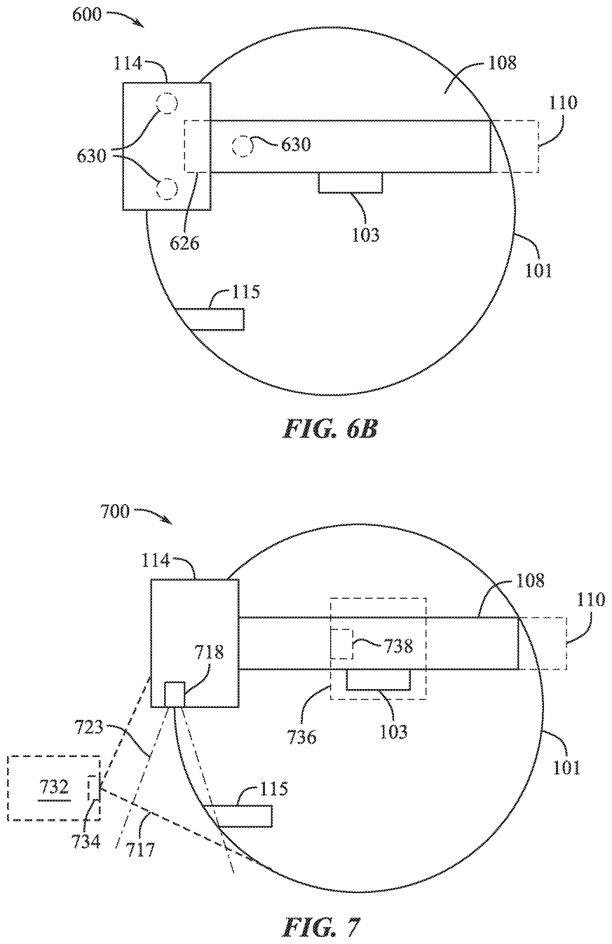

In addition to optimizing accuracy of the predicted dictation 427, the non-visual data 429 and/or the additional visual data 431 can be used to trigger a silent dictation mode of the head-mountable device, as described below with respect to FIGS. 5-6B. For example, the silent dictation mode can be activated in response to at least one camera or sensor detecting a person within a threshold vicinity or distance of the at least one camera or sensor. A threshold vicinity can refer to a maximum distance between the person and the user of the head-mountable device before which the silent dictation mode is activated. In other words, if the person is within the threshold vicinity (closer to the user than the predetermined maximum distance), the silent dictation mode can be activated. On the other hand, if the person is outside the threshold vicinity (further from the user than the predetermined maximum distance), the silent dictation mode can be de-activated, or otherwise not activated. In some examples the user can manually, verbally, or digitally activate the silent dictation mode on the device itself.

Any of the features, components, and/or parts, including the arrangements and configurations thereof shown in FIGS. 3-4 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3-4. Additional details of additional sensors to obtain visual data and non-visual data are described below in reference to FIG. 5 and FIGS. 6A-6B, respectively.

FIG. 5 illustrates a front view profile of a head-mountable device 500 with cameras 218, 520, and 522, according to one example. The head-mountable device 500 can be substantially similar to or the same as the head-mountable devices 100/200 of FIGS. 1-2, as noted by similar or identical reference numbers.

The head-mountable device 500 can include a vision sensor, such as the camera 218 oriented externally in a downward direction toward the user's mouth 115. The head-mountable device 500 can include a second sensor including an internal-facing camera 520. The head-mountable device 500 can include a third sensor including an external-facing camera 522 oriented externally in an outward direction away from the user's face.

The camera 218 can be configured to obtain the visual data. The internal-facing camera 520, and the external-facing camera 522 can be used to obtain additional visual data, such as the additional visual data 431 described in reference to FIG. 4. Further, the internal-facing camera 520 and the external-facing camera 522 can be used to initiate various functions of the head-mountable device.

The internal-facing camera 520 can have a field of view that encompasses at least one eye 105 of the user. In some examples, the head-mountable device 500 includes two internal-facing cameras 520 each having a field of view including each eye 105 of the user.

The internal-facing camera 520 can be used for an input selection of elements, such as application icons, menus, setting icons, etc. based on eye gaze. For example, the user can input a selection when the user directs their eyes toward the corresponding region of the display 102. The internal camera 520 can identify a line of sight of the user corresponding to the user's element selection (e.g., a user directing their line of sight towards a keyboard icon can cause a keyboard to visually appear on the display 102).

The internal-facing camera 520 can additionally or alternatively be used to monitor the user's eyes 105. For example, pupil dilation can be used to indicate the user's mood or sense of urgency which can be used to assist in generating the predicted dictation.

The external-facing camera 522 can have a field of view that encompasses a region in front of the user's face (e.g., opposite to the side of the display 102 viewed by the user). The field of view of the external-facing camera 522 can encompass a region that includes the hands and/or at least part of the arms of the user.

The external-facing camera 522 can be used to confirm the selection of elements from the internal-facing camera 520. For example, following a selection of an element determined by the internal-facing camera 520, the external-facing camera 522 can detect a hand gesture indicating confirmation of the input selection. In other terms, the user can use hand gestures to confirm that the selection of the element is appropriate.

The external-facing camera 522 can additionally or alternatively be used to monitor the user's hands and/or arms. For example hand gestures can also be used to indicate the user's mood or sense of urgency which can be used to assist in generating the predicted dictation.

The additional visual data 431 from the internal-facing camera 520 and the external-facing camera 522 can be used to trigger the head-mountable device 500 to enter a silent dictation mode (also referred to as a silent text input mode). For example, the external-facing camera 522 can detect nearby persons within a vicinity, or predetermined distance, of the user and either automatically trigger the silent dictation mode or offer a prompt for the user to select the silent dictation mode. In some examples, the user can preset a threshold distance of persons in their vicinity to trigger the silent dictation mode.

FIGS. 6A-6B illustrate a front view profile and a side view profile, respectively, of a head-mountable device 600 with non-visual sensors, according to one example. The head-mountable device 600 can be substantially similar to or the same as the head-mountable devices 100/200/500 of FIGS. 1-2 and FIG. 5, as noted by similar or identical reference numbers.

The head-mountable device 600 can include an array of sensors of varying types. In at least one example, in addition to the vision sensor 106 or cameras 218, the head-mountable device 600 can include a second sensor and/or a third sensor. The second sensor and/or the third sensor can be motion sensors disposed in proximity to the zygoma regions 109 or the maxilla regions 111 of the face of the user. The second sensor and/or the third sensor can be positioned in direct contact with the face of the user and can be configured to detect at least one of a facial vibration or deformation. For example, the motion sensors (the second and third sensors) can be pressure sensors or strain gauges. In certain implementations, the second sensor can be a zygoma-region sensor 624, and the third sensor can be a maxilla region sensor 626.

The zygoma-region sensor 624 can be disposed on or within the facial interface 104 or the arms 108 near the adjacent zygomatic bone structure of the zygoma region 109. The head-mountable device 600 can include a single zygoma-region sensor 624 (e.g., on one side of the facial interface 104 or on a single arm 108) or the head-mountable device 600 can include two or more zygoma-region sensors 624. The zygoma-region sensor 624 can be configured to detect facial vibrations corresponding to jaw movements when the user moves their mouth 115 to speak or to (silently) mouth words or phrases. Based on the detected facial vibrations from the zygoma-region sensor 624, the head-mountable device 600 can be triggered to enter a silent dictation mode, wherein the predicted dictation is based on visual data, such as the visual data 323 described in reference to FIGS. 3-4.

The maxilla region sensor 626 can be disposed on or within the facial interface 104 near the adjacent fleshy maxilla tissue of the maxilla region 111. The head-mountable device 600 can include a single maxilla-region sensor 626 or the head-mountable device 600 can include two or more maxilla-region sensors 626. The maxilla-region sensor 626 can be disposed on or within the facial interface 104 to track movement or deformation of the maxilla region 111. For example, the maxilla-region sensor 626 can be configured to detect jaw motion or an “up-and-down” motion of the jaw. In some examples, the maxilla-region sensor 626 can allow the head-mountable device 600 to differentiate between jaw motion corresponding to a dictation and jaw motion corresponding to other activities, such as chewing.

In some examples, the head-mountable device 600 can include additional sensors, such as an inertial measurement unit (IMU) 628, including an accelerometer, a gyroscope, a force meter, or the like, configured to measure linear acceleration, angular acceleration (rotation), orientation, and other forces. The IMU 628 can be a motion sensor disposed along or within the facial interface 104 or the display frame 114 and in direct contact with the face of the user.

In some examples, the IMU 628 can be configured to send and/or receive signals via wired or wireless connections to a processor (e.g., for activating an optical dictation sensor or vision sensor). Some particular examples of wireless communication or a communicative coupling include a Wi-Fi based communication, mesh network communication, BLUETOOTH® communication, near-field communication, low-energy communication, Zigbee communication, Z-wave communication, and 6LoWPAN communication. Other forms of communication (or communicative coupling) include wired connections, such as a USB connection, UART connection, USART connection, I2C connection, SPI connection, QSPI connection, etc.

In some examples, the head-mountable device 600 can include additional non-visual sensors 630, such as a respiration tracker, pulse monitor, temperature sensor, or other biometric sensors. Such non-visual sensors can be disposed at varying positions on the head-mountable device 600, such as on or within the facial interface 104 or the display frame 114, on the arms 108, on the strap 110, in the electronics pod 116, etc.

In some examples, the processor can activate the silent dictation mode (also referred to herein as a silent text input mode) in response to receiving additional sensor data. The additional sensor data can include the additional visual data 431 (as described in reference to FIGS. 4-5) and/or the non-visual data 429 (as described in reference to FIG. 4 and FIGS. 6A-6B). In an additional or alternate example, the silent dictation mode can be activated responsive to detection based on the additional sensor data, of a person within a threshold vicinity of the user.

For example, the processor can activate the silent dictation mode in response to receiving additional visual data 431 from the internal-facing camera 520 or the external-facing camera 522; second sensor data from the second sensor; and/or third sensor data from the third sensor. In other terms, based on the detected jaw motion (e.g., during dictation) or other facial vibration, strain, or pressure parameters, a processor—communicatively coupled to one or more sensors such as a motion sensor—of the head-mountable device 600 can transmit a signal to an optical dictation sensor and activate the silent dictation mode.

In at least one example, the silent dictation mode of the head-mountable device 600 can be manually initiated by the user. In other words, the silent dictation mode can be activated in response to detecting a user input to dictate. For example the user can manually push a button, input a selection (e.g., via the internal-facing camera 520 and/or the external-facing camera 522), audibly speak a command, etc.

In at least one example, initiation of the silent dictation mode can be time based. For example, the user can set a schedule to initiate the silent dictation mode at night and during school/work hours. Additionally or alternatively, the user can set the head-mountable device 600 in an audible dictation mode for a period of time (one week, one month, etc.) to allow the head-mountable device 600 to learn and retain the user's speech patterns to be subsequently used to generate the predicted dictation.

Although the head-mountable device 200 of FIG. 2, the head-mountable device 500 of FIG. 5, and the head-mountable device 600 of FIG. 6 are described above independently, related head-mountable devices of this disclosure include head-mountable devices that can include any, all, or a combination of the cameras and sensors of any of the head-mountable devices 200/500/600.

Any of the features, components, and/or parts, including the arrangements and configurations thereof shown in FIGS. 5-6B can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5-6B. Details of systems including the head-mountable device and additional sensors are described below in reference to FIG. 7.

FIG. 7 illustrates a side view profile of a head-mountable device 700 communicatively coupled to an electronic device 732 including a first sensor 734, according to one example. The head-mountable device 700 can be substantially similar to or the same as the head-mountable devices 100/200/500/600 of FIGS. 1-2 and FIGS. 5-6, as noted by similar or identical reference numbers. In particular, the head-mountable device 700 can include any of the cameras and sensors, such as cameras 218, internal-facing cameras 520, external-facing cameras 522, zygoma-region sensors 624, maxilla-region sensors 626, IMUs 628, and additional sensors 630.

A system can include a wearable device, such as the head-mountable device 700. The head-mountable device 700 can be communicatively coupled to the electronic device 732 including the first sensor 734. The electronic device 732 can be an external client device, such as a cellular device, a laptop, a tablet, a desktop computer, or another wearable apparatus (smart watch). The head-mountable device 700 can include a second sensor 718.

In one example, the first sensor 734 and the second sensor 718 can be the same type of sensor, such as an optical sensor. The first sensor 734 can be an optical sensor or a camera oriented in a first orientation and the second sensor 718 can be an optical sensor or camera oriented in a second orientation that differs from the first orientation. Particularly, in the first orientation, the first sensor 734 can include a full view of the mouth 115 of the user; and in the second orientation, the second sensor 718 can include a partial view of the mouth 115 of the user. For example, the first sensor 734 can be a camera of the electronic device 732 that is pointed at the user, such that its field of view 717 includes a full view of the mouth 115. The second sensor 718 can be a camera of the head-mountable device 700 that is oriented externally in a downward direction such that, when the head-mountable device 700 is donned on the user's head, its field of view 723 includes a partial view of the mouth 115.

In an additional or alternative example, the head-mountable device 700 can be communicatively coupled to an electronic device 736 including a sensor 738. The electronic device 736 can be a wearable electronic device, such as an earbud or a pair of earbuds, in direct contact with the user's head. The sensor 738 can be a first type of sensor, and the second sensor 718 can be a second type of sensor that differs from the first type of sensor. For example, the second type of sensor can be an acoustic sensor, a pressure sensor, a strain gauge, a vibration detector, a breath detector, or a biometric sensor, and the first type of sensor can be a camera or optical sensor, such as the camera 218. In some examples, the first type of sensor and the second type of sensor can be optical sensors.

The head-mountable device 700 can further include a processor and a memory device. The processor and the memory can be included in the electronics pod 116 of FIG. 1. The memory device can store instructions that, when executed by the processor, cause the processor to: i) identify sensor data from the first sensor 734 and/or the sensor 738 (first sensor data and third sensor data, respectively); and the second sensor 718 (second sensor data), ii) generate a predicted dictation based on the sensor data, and iii) present, for display at the wearable device (e.g., the head-mountable device 700), a graphical representation of the predicted dictation. A graphical representation can be a visual output, such as an image output or a text output, or can be another visual output of the head-mountable device 700 that is output by the display 102. The predicted dictation can be based on the sensor data. In one example, the processor can generate an initial predicted dictation based on second sensor data from the second sensor 718 and the processor generate a final predicted dictation (e.g., for display at the wearable device) based on first sensor data from the first sensor 734 and/or third sensor data from the sensor 738. In other terms, processor can use the first sensor data from the first sensor 734 (and/or third sensor data from the sensor 738) to improve accuracy of the final predicted dictation.

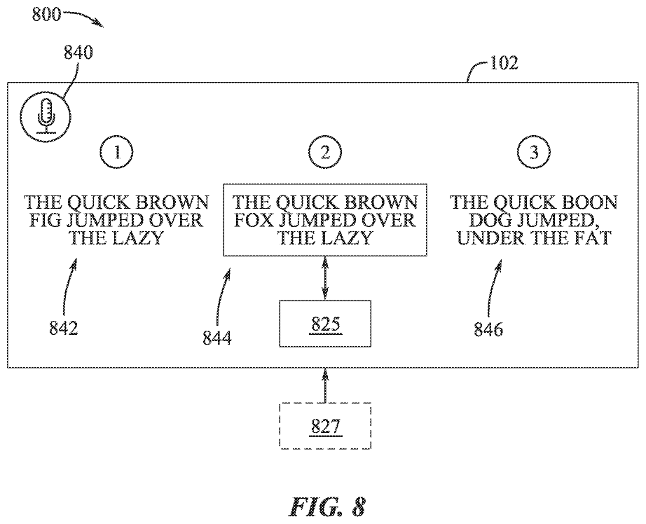

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7. Details of a user interface (UI) for displaying predicted dictation are described below in reference to FIG. 8.

FIG. 8 illustrates a user interface (UI) displaying a graphical representation of predicted dictation displayed on the display 102 of a head-mountable device 800, according to one example. The display 102 can be a display of any of the head-mountable devices, such as the head-mountable devices 100, 200, 500, 600, or 700, described herein.

The display 102 can include an indication 840 indicating a dictation mode of the head-mountable device 800. The indication 840 can indicate whether the head-mountable device 800 is operating in an audible dictation mode (wherein the head-mountable device 800 can receive text input from audibly spoken commands from the user) or in a silent dictation mode (wherein the head-mountable device 800 can generate predicted dictation from silently mouthed commands from the user). In one example, the indication 840 can be represented by a microphone symbol in the audible dictation mode and the indication 840 can be represented by a microphone symbol interrupted by an “x,” a slash, a cross, or the like in the silent dictation mode.

In the silent dictation mode, the camera(s) 218 (or other vision sensor(s) 106) detect mouth movement of the mouth 115 of the user. The display 102 can be configured to display one or more predicted dictations, such as a first predicted dictation 842, a second predicted dictation 844, a third dictation 846, and in some cases, additional predicted dictations. As described above, the predicted dictations can be based at least in part on contextual awareness. Contextual awareness can in some examples refer to sensor data or other contextual data relating to the user's location, physical state (e.g., biometric data) current activities, browser searches and search history, messaging data, etc. In some examples, the predicted dictations can be further based at least in part by non-visual data and/or additional visual data.

The user can select an intended predicted dictation based on eye selection 825, for example by directing their eye gaze towards the corrected predicted dictation. The user can also confirm their selection using a hand gesture 827.

For example, as depicted in FIG. 8, the user can select the second predicted dictation 844 via eye selection 825 and confirm their selection of the second predicted dictation 844 via a hand gesture 827.

In some examples, if none of the first predicted dictation 842, the second predicted dictation 844, the third predicted dictation 846, or other predicted dictations are correct, the user can use a different method to enter their intended dictation. In at least one example, generating the predicted dictation includes using a machine-learning model. The head-mountable device 800 can be configured to use one or more machine-learning models to generate and improve accuracy of the predicted dictations. At least one such machine-learning model can include a feedback loop, which in response to the user input to correct or confirm the predicted dictation, updates a parameter of the machine-learning model.

Inputs from camera(s) 218, cameras 520 and 522, and other external electronic device sensors such as the vision sensor 106, sensors 112, zygoma-region sensors 624, maxilla-region sensors 626, IMUs 628, non-visual sensors 630, sensors 718, as described above with reference to FIGS. 1-7 can be utilized individually or in combination to generate the predicted dictation. Further, in some examples, these inputs can be utilized by a machine learning model to generate the predicted dictation (as described above in relation to FIG. 4).

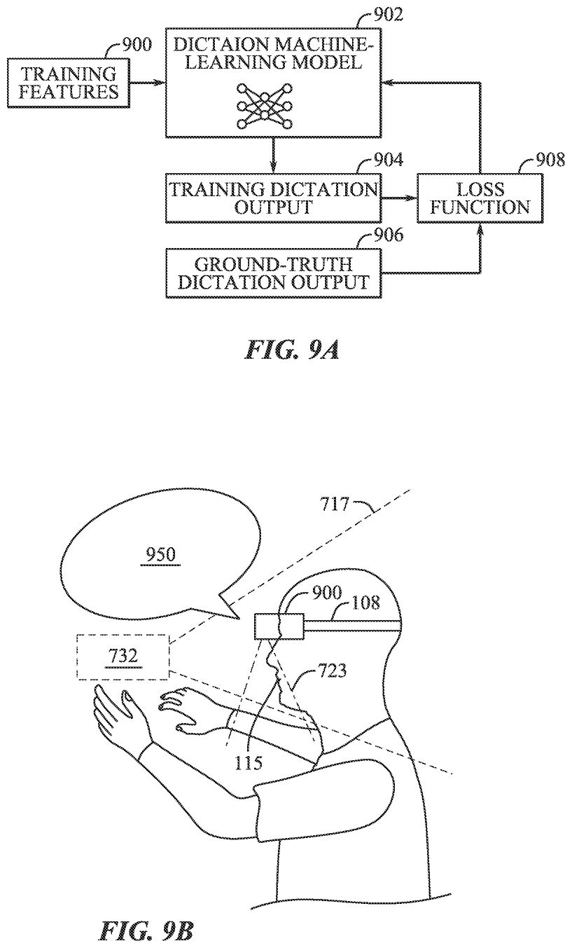

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8. Additional details of training a machine-learning model to generate a predicted dictation are described below in reference to FIGS. 9A-9B.

FIG. 9A illustrates training a dictation machine-learning model 902 of a head-mountable device in accordance with one or more examples of the present disclosure. As used herein, the term “dictation machine-learning model” (or more generally, a “machine-learning model”) refers to a model with one or more processes that can be tuned (e.g., trained) based on inputs to approximate unknown functions. In particular, a machine-learning model of the present disclosure can learn to approximate complex functions and generate outputs based on inputs provided to the model. For instance, the disclosure describes in more detail below, in conjunction with the figures, a dictation machine-learning model. In particular, one or more systems (or system components, such as a computing device, server, head-mountable device, etc.) can train the dictation machine-learning model to accurately generate predicted dictations. Such a machine-learning model can include, for example, linear regression, logistic regression, decision trees, naïve Bayes, k-nearest neighbor, neural networks, long-short term memory, random forests, gradient boosting models, deep learning architectures, classifiers, a combination of the foregoing, etc.

As shown in FIG. 9A, the dictation machine-learning model 902 can receive training features 900 to generate a training dictation output 904. The training features 900 can include a variety of different training model inputs. In some examples, the training features 900 can include audio recordings (e.g., audio clips at speaking volume between about 40 dB and about 70 dB, audio clips at whisper volume between about 20 dB and about 50 dB, etc.). Additionally or alternatively, the training features 900 can include voice data, voice biometric markers, etc. In certain examples, the training features 900 can include video recordings, photos, or other visual data (e.g., video recordings of one or more lips moving as a user dictates). In some examples, the visual data can include different orientations or angles of a field of view that at least partially includes a user's mouth (e.g., a profile view from a user-facing device with a full field of view of the user's mouth, a downward angled view from a jaw camera with a partial field of view of the user's mouth, etc.).

In some examples, the training features 900 can include user data, including historical data. User data can include application data, such as message data, calendar data, voicemail data, social media data, video communication data (e.g., ZOOM® call recordings and/or transcriptions), etc. In certain implementations, the user data can include conversation data from audio data and/or phone call data. Similarly, the user data can include environment data (e.g., location data, weather data, ambient noise data, user activity data, etc.). In particular examples, the user data includes user preferences, language data, accent or dialect data, user corrections to predicted dictations, etc.

Based on the training features 900, the dictation machine-learning model 900 can generate the training dictation output 904 in one or more initial training iterations. The training dictation output 904 can include a predicted dictation or transcription of spoken or mouthed words/phrases. In some examples, the training dictation output 904 includes estimated verbiage, a recommended phrase or sentence, a suggested message, a predicted narration, etc.

As part of the training iteration, one or more systems (or system components, such as a computing device, server, head-mountable device, etc.) can compare the training dictation output 904 with ground-truth dictation output 906 to determine a loss using a loss function 908. In these or other examples, the ground-truth dictation output 906 can include various types of data used as factual data to compare against the training dictation output 904. In some examples, the ground-truth dictation output 906 includes actual dictation data, verified dictation data, corrected dictation data, text samples read/mouthed by a user, etc.

The loss function 908 can include, but is not limited to, a regression loss function (e.g., a mean square error function, a quadratic loss function, an L2 loss function, a mean absolute error/L1 loss function, mean bias error). Additionally, or alternatively, the loss function 908 can include a classification loss function (e.g., a hinge loss/multi-class SVM loss function, cross entropy loss/negative log likelihood function).

Further, the loss function 908 can return quantifiable data regarding the difference between the training dictation output 904 and the ground-truth dictation output 906. In particular, the loss function 908 can return such loss data to the dictation machine-learning model 902 based upon which the system (e.g., a computing device, server, head-mountable device, etc.) adjusts various parameters/hyperparameters to improve the quality/accuracy of training dictation output in subsequent training iterations—by narrowing the difference between training dictation output and ground-truth dictation output. It will be appreciated that the training of the dictation machine-learning model can be an iterative process (as shown by the return arrow between the loss function 908 and the dictation machine-learning model 902) such that the system can continually adjusts parameters/hyperparameters of the dictation machine-learning model 902 over training iterations.

FIG. 9B illustrates a system for training a head-mountable device of the present disclosure to generate a predicted dictation, according to one example. Although not all components are shown, the head-mountable device is the same as or similar to the head-mountable devices 100/200/500/600/700/800.

In at least one example, a machine-learning model for generating predicted dictation can be initialized when the user begins use of (or wishes to enhance use of) the head-mountable device. The machine-learning model can be the machine-learning models 325 or 425, the dictation machine-learning model 902 described in reference to FIG. 9A, or other appropriate machine-learning model. Upon using the device for the first time, the head-mountable device can receive sensor data from a vision sensor with a field of view 723 partially including the user's mouth 115. The vision sensor can be the camera 218, the vision sensor 106, or other vision sensor. The user can be prompted to silently dictate or mouth predetermined phrases, letters, numbers, or sounds, which can be used as training inputs for the machine-learning model.

In some further examples, the machine-learning model can be further trained using an external electronic device 732, such as a cellular phone, tablet, personal computer, etc. The field of view 717 of the electronic device can include a full view of the mouth 115 of the user. The machine-learning model can use additional visual data obtained by the external electronic device 732 to optimize (e.g., improve or enhance the accuracy of) the machine-learning model predicted dictation.

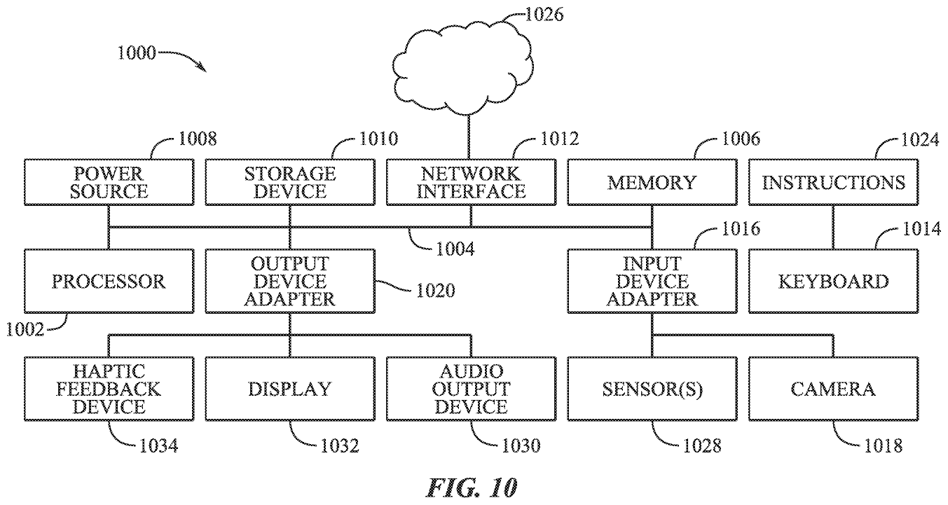

Any of the features, components, and/or parts, including the arrangements and configurations thereof shown in FIGS. 9A-9B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 9A-9B. Additional details of training a head-mountable device to generate a predicted dictation are described below in reference to FIG. 10.

FIG. 10 shows a high-level block diagram of a computer system 1000 that can be used to implement examples of the present disclosure. In various examples, the computer system 1000 can include various sets and subsets of the components shown in FIG. 10. Thus, FIG. 10 shows a variety of components that can be included in various combinations and subsets based on the operations and functions performed by the computer system 1000 in different examples. In at least one example, the computer system 1000 can be part of the head-mountable devices 100, 200, 500, 600, 700, 800, and 900 described above in connection with FIGS. 1-9. It is noted that, when described or recited herein, the use of the articles such as “a” or “an” is not considered to be limiting to only one, but instead is intended to mean one or more unless otherwise specifically noted herein.

The computer system 1000 can include a central processing unit (CPU) or processor 1002 connected via a bus 1004 for electrical communication to a memory device 1006, a power source 1008, an electronic storage device 1010, a network interface 1012, an input device adapter 1016, an output device adapter 1020, and a display. For example, one or more of these components can be connected to each other via a substrate (e.g., a printed circuit board (PCB) or other substrate) supporting the bus 1004 and other electrical connectors providing electrical communication between the components. The bus 1004 can include a communication mechanism for communicating information between various parts of the computer system 1000.

The processor 1002 can be a microprocessor or similar device configured to receive and execute a set of instructions 1024 stored by the memory device 1006. The memory device 1006 can be referred to as main memory, such as random access memory (RAM) or another dynamic electronic storage device for storing information and instructions to be executed by the processor 1002. The memory device 1006 can also be used for storing temporary variables or other intermediate information during execution of instructions executed by the processor 1002. The processor 1002 can include one or more processors or controllers, such as, for example, a CPU for the processor 1002 or input devices 100, 200, 500, 600, 700, 800, and 900 in general and a touch controller or similar sensor or input/output (I/O) interface used for controlling and receiving signals from the display 1032 (e.g., display 102) and any other sensors being used (e.g., vision sensor 106, sensors 112, camera(s) 218, cameras 520 and 522, zygoma-region sensors 624, maxilla-region sensors 626, IMUs 628, non-visual sensors 630, sensors 718, and other external electronic device sensors such as sensor 734 and 738). The power source 1008 can include a power supply capable of providing power to the processor 1002 and other components connected to the bus 1004, such as a connection to an electrical utility grid or a battery system.

The storage device 1010 can include read-only memory (ROM) or another type of static storage device coupled to the bus 1004 for storing static or long-term (i.e., non-dynamic) information and instructions for the processor 1002. For example, the storage device 1010 can comprise a magnetic or optical disk (e.g., hard disk drive (HDD)), solid state memory (e.g., a solid state disk (SSD)), or a comparable device.

The instructions 1024 can include information for executing processes and methods using components, such as the processor 1002, of the computer system 1000. Such processes and methods can include, for example, the methods described in connection with other examples elsewhere herein for generating predicted dictations.

The network interface 1012 can comprise an adapter for connecting the system 1000 to an external device via a wired or wireless connection. For example, the network interface 1012 can provide a connection to a computer network 1026 such as a cellular network, the Internet, a local area network (LAN), a separate device capable of wireless communication with the network interface 1012, other external devices or network locations, and combinations thereof. In one example, the network interface 1012 is a wireless networking adapter configured to connect via WI-FI®, BLUETOOTH®, Bluetooth Low-Energy (BLE), Bluetooth mesh, or a related wireless communications protocol to another device having interface capability using the same protocol. In some examples, a network device or set of network devices in the network 1026 can be considered part of the computer system 1000. In some cases, a network device can be considered connected to, but not a part of, the computer system 1000.

The input device adapter 1016 can be configured to provide the computer system 1000 with connectivity to various input devices such as, for example, cameras 1018 (camera(s) 218 or cameras 520 and 522), and other external electronic device sensors such as sensors 1028 (vision sensor 106, sensors 112, zygoma-region sensors 624, maxilla-region sensors 626, IMUs 628, non-visual sensors 630, sensors 718), and other external electronic device components, such as touch input devices, a keyboard 1014, or other peripheral input device, related devices, and combinations thereof. In an example, the input device adapter 1016 is connected to the cameras and sensors described herein to detect mouth movement of the user's mouth and/or facial vibration, strain, deformation, etc. One or more sensors, which can include any of the sensors of input devices described herein, can be used to detect physical phenomena in the vicinity of the computing system 1000 (e.g., light, sound waves, electric fields, forces, vibrations, etc.) and convert those phenomena to electrical signals. In some examples, the input device adapter 1016 can be connected to a stylus or other input tool, whether by a wired connection or by a wireless connection (e.g., via the network interface 1012) to receive input.

In at least one example, the memory device 1006 can store instructions 1024 that, when executed by the processor 1002, cause the processor 1002 to convert visual data (for example from the camera(s) 218) of mouth movement of a mouth of the user to a text input. In one example, the processor 1002 can active a silent text input mode of the computer system 1000 in response to receiving data from sensors 1028.

In at least one example, the memory device 1006 can store instructions 1024 that, when executed by the processor 1002, cause the processor to identify sensor data from a first sensor, such as the camera 218, and from a second sensor (such as one or more of sensors 1028); generate a predicted diction based on the sensor data; and present, for display at the computer system 1000, a graphical representation of the predicted dictation.

The output device adapter 1020 can be configured to provide the computer system 1000 with the ability to output information to a user, such as by providing visual output using one or more display, such as the display 102, by providing audible output using one or more speakers or audio output devices, or providing haptic feedback sensed by touch via one or more haptic feedback devices 1034. Other output devices can also be used. The processor 1002 can be configured to control the output device adapter 1020 to provide information to a user via the output devices connected to the adapter 1020.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. A head-mountable device, comprising:
a display;
a display frame disposed around the display;
a vision sensor carried by the display frame and oriented externally in a downward direction that, when the head-mountable device is donned on a head of a user, is configured to detect mouth movement;
a processor; and
a memory device storing instructions that, when executed by the processor, cause the processor to convert visual data of the mouth movement to a text input.

2. The head-mountable device of claim 1, further comprising an additional sensor configured to detect at least one of a facial vibration or a facial deformation.

3. The head-mountable device of claim 2, wherein the additional sensor is positioned in direct contact with a face of the user.

4. The head-mountable device of claim 2, wherein the processor activates a silent text input mode in response to receiving sensor data from the additional sensor.

5. The head-mountable device of claim 1, further comprising:
a second sensor including an internal-facing camera to detect an input selection based on eye gaze; and
a third sensor including an external-facing camera to detect a hand gesture indicating confirmation of the input selection.

6. A system, comprising:
a wearable device communicatively coupled to an electronic device comprising a first sensor, the wearable device comprising:
a second sensor;
a processor; and
a memory device storing instructions that, when executed by the processor, cause the processor to:
identify sensor data from the first sensor and the second sensor;
generate a predicted dictation based on the sensor data; and
present, for display at the wearable device, a graphical representation of the predicted dictation.

7. The system of claim 6, wherein:
the first sensor is a first type of sensor; and
the second sensor is a second type of sensor different from the first type of sensor.

8. The system of claim 7, wherein:
the first type of sensor comprises a camera; and
the second type of sensor comprises at least one of an acoustic sensor, a pressure sensor, a strain gauge, a vibration detector, a breath detector, or a biometric sensor.

9. The system of claim 6, wherein:
the first sensor is oriented in a first orientation; and
the second sensor is oriented in a second orientation different from the first orientation.

10. The system of claim 9, wherein:
in the first orientation, the first sensor has a full view of a mouth of a user; and
in the second orientation, the second sensor has a partial view of the mouth of the user.

11. The system of claim 6, wherein the electronic device comprises an external client device.

12. The system of claim 6, wherein generating the predicted dictation comprises utilizing contextual awareness.

13. The system of claim 12, wherein the contextual awareness comprises user activity.

14. The system of claim 6, wherein the memory device further comprises instructions that, when executed by the processor, cause the processor to activate a silent dictation mode in response to at least one sensor of the wearable device detecting a person within a threshold vicinity of the at least one sensor.

15. The system of claim 6, wherein generating the predicted dictation includes using a machine-learning model.

16. A wearable apparatus, comprising:
a display housing including an optical dictation sensor;
a display positioned within the display housing; and
a facial interface connected to the display housing, the facial interface including a motion sensor, the motion sensor and the optical dictation sensor communicatively coupled to a processor.

17. The wearable apparatus of claim 16, wherein the motion sensor is disposed in proximity to a zygoma region or a maxilla region of a face of a user when donned.

18. The wearable apparatus of claim 16, wherein the motion sensor comprises at least one of a pressure sensor or a strain gauge.

19. The wearable apparatus of claim 16, wherein the optical dictation sensor includes a pair of vision sensors positioned within the display housing.

20. The wearable apparatus of claim 16, further including a memory device and the processor, the memory device comprising instructions that, when executed by the processor, cause the processor to activate a silent dictation mode in response to detecting a user input to dictate.
